(19) United States
(12) Patent Application Publication
(10) Pub. No.: US 2019/0299225 A1
(43) Pub. Date: Oct. 3, 2019

(54) Liquid-Jet Nozzle

(71) Applicant: Aebi Schmidt Nederland BV, PJ Holten (NL)

(72) Inventors: Felix Lugtenberg, Raalte (NL); Richard Pauwels, Almelo (NL)

(73) Assignee: Aebi Schmidt Nederland BV, PJ Holten, NETHERLANDS

(21) Appl. No.: 16/434,517

(22) Filed: Jun. 7, 2019

Related U.S. Application Data
(63) Continuation of application No. PCT/EP2017/081450, filed on Dec. 5, 2017.

(30) Foreign Application Priority Data
Dec. 9, 2016 (DE) 102016123994.1

(51) Int. Cl. B05B 1/30; B05B 1/06

(52) U.S. Cl. CPC B05B 1/3006; B05B 1/3402; B05B 1/06

(57) ABSTRACT

A liquid jet nozzle comprises a housing (1) with a liquid inlet opening (2) and a jet outlet opening (3), and comprises a jet forming area (S) which is arranged between the liquid inlet opening (2) and the jet outlet opening (3) and which has a flow channel, the passage cross-section of which can be altered. In the jet forming area (S), the flow channel is radially outwardly delimited by an elastically deformable funnel membrane (12), the outer periphery of which is permanently sealed to the housing (1) and which is tapered in the throughflow direction (A). In order to automatically alter the passage cross-section according to the local liquid pressure, the funnel membrane radially expands when the liquid pressure increases, and radially contracts when the liquid pressure decreases.

The present invention relates to a liquid jet nozzle comprising a housing which has a liquid inlet opening, and a jet outlet opening, and comprising a jet forming area which is arranged between the liquid inlet opening and the jet outlet opening and which has a flow channel, the passage cross-section of which can be altered.

Such a jet nozzle, for example, is known from DE 102014018130 A1. As described in detail in that document, different from spray nozzles which are designed and intended to form fine droplets or a liquid mist, the purpose of jet nozzles is the formation of a liquid jet which does not disintegrate over as long a distance as possible. In order to achieve the desired reliable jet formation even with different liquid throughputs through the jet nozzle, the jet nozzle known from DE 102014018130 A1 comprises a throttle sleeve which is displaceable relative to the housing and the jet forming body and preloaded against the flow direction of the jet forming body by means of a spring mechanism. The throttle sleeve comprises an annular piston section routed in a pre-compression chamber that communicates with the liquid inlet, and a passage which interacts with the cone area of the jet forming body and together with the same defines an annular passage cross-section, the cross-section area of which changes in accordance with the given operating mode.

The objective of the present invention is to provide a further improved jet nozzle of the type indicated above with regard to its operating behavior, in particular an improved reproducibility of the jet formation with varying liquid throughputs.

A solution for the above challenge according to the present invention is achieved in that a jet nozzle of the type indicated above in combination with
a jet forming body with free circumflow is arranged in the housing with an end section that is tapered in the direction of the jet outlet opening,
between the housing and the jet forming body on at least a portion of the axial length thereof an annular flow channel is configured,
in the jet forming area, the flow channel is delimited radially outwardly by an elastically deformable funnel membrane, which at its outer periphery is permanently sealed to the housing and tapered in the throughflow direction. In order to automatically alter the passage cross-section according to the local liquid pressure, the funnel membrane radially expands when the liquid pressure increases, and radially contracts when the liquid pressure decreases,
the alterable passage cross-section is ring-shaped and the jet forming body extends into the funnel membrane, and
the housing comprises at least one opening by which the inside of the housing in the jet forming area is laterally vented.

Thus, for the proposed liquid jet nozzle, the passage cross-section, the cross-section of which changes subject to and depending on the operating conditions, is defined by an elastically deformable funnel membrane, the outer periphery of which (largest circumference) is permanently sealed to the housing. Depending on the local liquid pressure, i.e., the liquid pressure in the funnel membrane, said funnel membrane changes its geometry. With increasing liquid pressure, the funnel membrane will radially expand—in its area downstream from the seal connection to the housing—and with decreasing pressure the funnel membrane will radially contract in that area. In the process, the elastically deformable funnel membrane will thus react immediately and particularly sensitively to any change in the prevailing operating conditions. Hysteresis-caused limitations of the reproducibility, as they occur more or less pronounced with the generic jet nozzle described in DE 102014018130 A1 due to stick-slip effects of the throttle valve, can be avoided with the implementation of the present invention.

Furthermore, according to the invention, a jet forming body with free circumflow extending into the funnel membrane is arranged in the housing. Between the housing and the jet forming body on at least a portion of the axial length thereof an annular flow channel is configured. Furthermore, said jet forming body has an end section which is tapered in the direction of the jet outlet opening, especially preferably substantially cone-shaped, and terminates in a pointed configuration. This creates an annular passage cross-section which is defined radially inwardly by the jet forming body and radially outwardly by the funnel membrane, the cross-section area of which decreases more or less continually over an axial extent in the throughflow direction of the jet nozzle and at the same time guides the flowing liquid via a radially inwardly directed component. This configuration (due to the steady acceleration of the liquid passing through the passage cross-section over said axial extent) results in flow conditions that particularly promote the formation of a stable liquid jet. An undisturbed jet formation with different throughputs and orientations of the jet nozzle is further supported by the proposed lateral ventilation of the housing interior in the jet forming area provided by means of the at least one opening on the housing.

To avoid misunderstandings, it is to be noted that the specification according to which the outer periphery of the elastically deformable funnel membrane is “permanently” sealed to the housing, is not to be misinterpreted in the sense of a permanent or non-detachable connection of the funnel membrane and the housing; this specification rather means that a change of the funnel membrane in the jet forming area, does not alter the tight connection of the funnel membrane (at its outer periphery) to the housing. Besides, and this is pointed out as a precautionary measure, a deformation of the funnel membrane due to increasing liquid pressure, which, apart from a radial expansion also includes an axial deformation portion, unrestrictedly falls under the above definition of the present invention.

In addition to its particularly sensitive dosing and control function, the funnel membrane can—with another suitable configuration of the liquid jet nozzle according to a preferred further embodiment (see below)—at the same time also reliably fulfill the function of a shutter when the liquid throughput returns to zero. This applies in particular to an annular configuration of the passage cross-section where it is radially outwardly delimited by the funnel membrane and radially inwardly by a jet forming body extending into said funnel membrane, whereby the inner periphery (smallest circumference) of the funnel membrane faces the outside of the jet forming body. With the liquid throughflow decreasing to zero, the elastic annular funnel membrane can—with its inner periphery—attach itself to the outside of the jet forming body and thus fully close the (annular) passage cross-section. However, within the scope of the present invention, a separate closing device—arranged upstream from the elastic funnel membrane—can be configured as well. As appropriate, this closing device itself can comprise an elastic membrane which fulfills a non-return function.

While such a configuration is not necessarily imperative under the present invention, another preferred embodiment of the proposed liquid jet nozzle is characterized in that the jet forming body is arranged immovably in the housing. Spoke-like structures that are provided upstream of the funnel membrane in an annular space between the housing and the jet forming body and hold the jet forming body can thus and in addition, when suitably dimensioned and/or profiled, also form flow guide surfaces.

And even the funnel membrane is particularly preferably affixed immovably at its outer periphery to the housing. This way, not only the proposed liquid jet nozzle can be fabricated with a particularly low manufacturing effort. By eliminating the movability of the jet forming body or the funnel membrane at its outer periphery, the previously described relevant considerations with respect to the excellent reproducibility of the operating behavior are also particularly marked.

According to yet another preferred embodiment of the present invention, the funnel membrane has a bead-shaped peripheral region. This is advantageous in regard to a tight and permanently firm fixation of the funnel membrane at its outer periphery to the housing of the liquid jet nozzle by simple means. In that sense, in particular in the area of the jet outlet opening of the housing, a removable holding ring may be provided that engages a clamp sleeve which itself effects a fixation of the outer periphery of the funnel membrane in the housing (to the bead-shaped outer peripheral region of the funnel membrane).

Ultimately, for the desired formation of a particularly stable liquid jet, it is favorable if the liquid inlet opening is arranged opposite of the jet outlet opening; because this eliminates redirections of flow which under certain operating conditions can adversely affect the formation of a particularly stable liquid jet.

In the following, the present invention is explained in more detail with reference to the drawing. In that, by means of a perspective axial section,

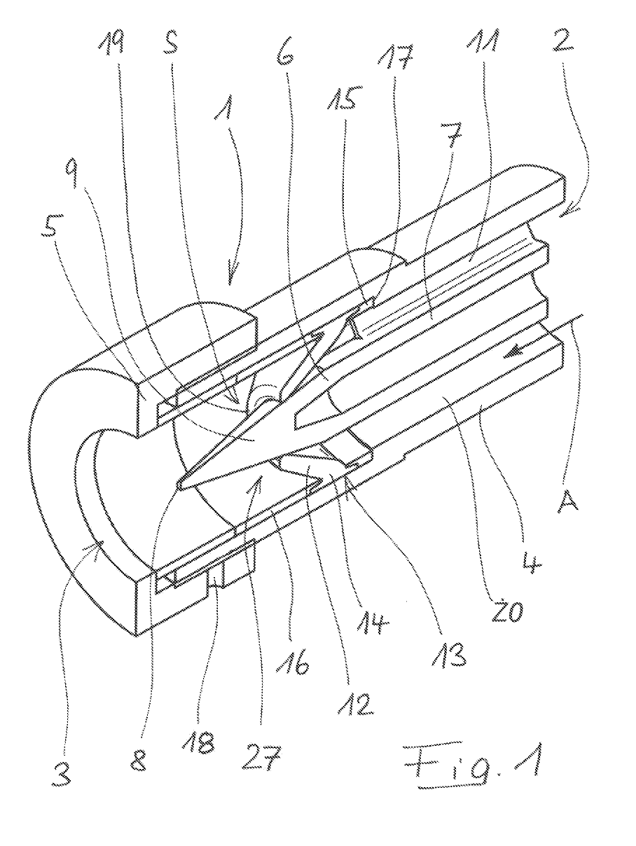

FIG. 1 shows a comparative example to aid with the understanding of the present invention and

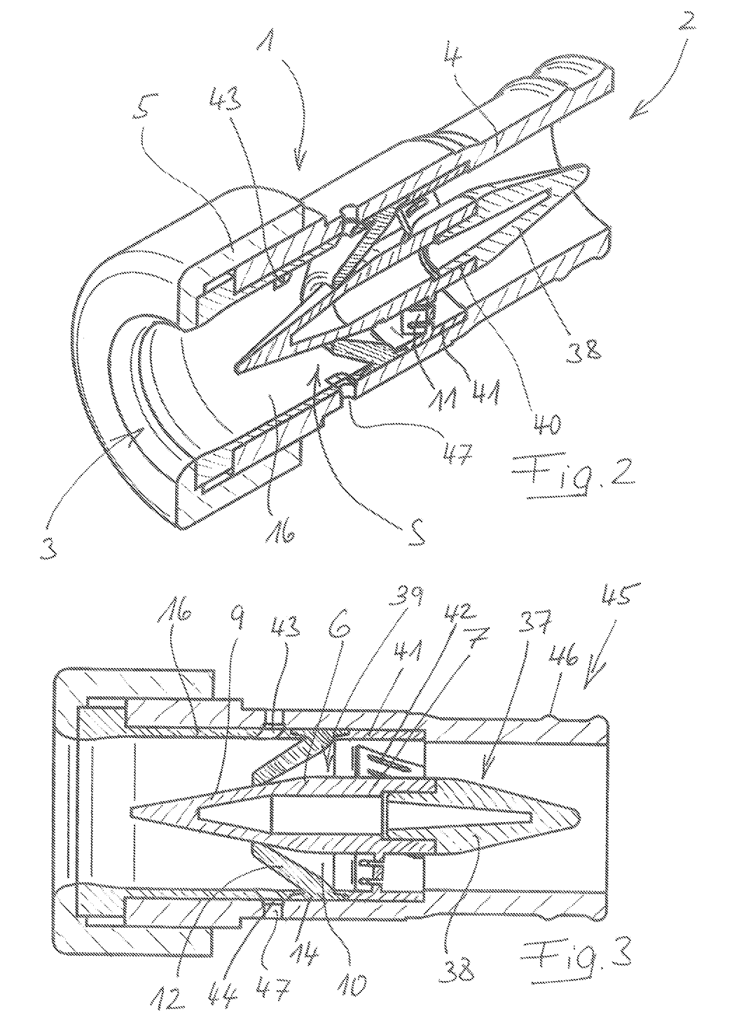

FIG. 2, by means of a perspective axial section, and

FIG. 3, by means of a orthogonal axial section, show a preferred embodiment of the invention.

The liquid jet nozzle illustrated in the drawing in FIG. 1 comprises a housing 1 having a liquid inlet opening 2 and a jet outlet opening 3. The liquid inlet opening 2 and the jet outlet opening 3 are thereby—in relation to the throughflow direction A—configured opposite each other so that the liquid jet formed in a jet forming area S exits the jet nozzle in the same direction in which the liquid enters the jet nozzle through the liquid inlet opening 2.

The housing 1 comprises a substantially sleeve-shaped main body 4 and a holding ring 5 which is screwed on endwise to the main body 4 in the area of the jet outlet opening 3 of the housing 1, the function of the holding ring 5 being further discussed below.

On the inside of the main body 4 of the housing 1 of the jet nozzle, a jet forming body 6 extends along the jet nozzle's axis. Said jet forming body 6 comprises a substantially cylindrical main area 7 and—configured downstream thereof in the throughflow direction A—an end section 9 which is tapered in the direction of the jet outlet opening 3, cone-shaped, and terminates in a point 8. Between the jet forming body 6 and the main body 4 of the housing 1 is an annular flow channel 10 for the liquid circumflowing the jet forming body 6. The jet forming body 6 is secured in the main body 4 of the housing 1 by means of several web-like spokes 11 bridging the annular flow channel 10. These spokes 11 extend in axial direction over a substantial portion of the main area 7 of the jet forming body 6 and thus act as flow guide surfaces that ensure an axial throughflow of the flow channel 10.

In the annular flow channel 10 an elastically deformable funnel-shaped membrane 12 is arranged in such a way that it is tapered in the throughflow direction. A from an outer periphery to an inner periphery. At its outer periphery 13, the funnel membrane 12 is sealed to the housing 1. For this purpose, a bead-shaped peripheral region 14 extends along the outer periphery 13 of the funnel membrane 12. Said peripheral region 14 is clamped between a clamping ring 15 and a clamp sleeve 16 which are both incorporated in the main body 4 of the housing 1 and at their front sides each feature a profile contoured to match the bead-shaped configuration of the peripheral region 14 of the funnel membrane 12. The clamping ring 15 is thereby supported by a step 17 on the main body 4 of the housing 1; the clamp sleeve 16, on the other hand, is engaged by the holding ring 5 mentioned earlier. A fixation of the holding ring to the main body 4 of the housing 1 in the set position can be achieved by means of a grub screw (not depicted) that is screwed into the threaded bore 18.

The funnel membrane 12, the axial extent of which is about equally proportioned as its outer diameter, is dimensioned in a way that, without any liquid supply to the liquid intake opening 2, its inner periphery 19 rests on the outside of the jet forming body 6, i.e., at the cone-shaped end section 9 thereof (refer to the operating mode illustrated in the drawing). In this manner, the funnel membrane 12 and the jet forming body 6 in interaction with each other form a closing device 27. With the supply of liquid to the liquid intake opening 2 of the housing 1, the inner periphery 19 of the funnel membrane 12 in turn lifts up from the jet forming body 6 and uncovers an annular passage opening, the cross-section area of which depends on the amount of supplied liquid or the pressure present upstream of the annular membrane 12.

To avoid misunderstandings, it needs to be pointed out that the drawing shows the jet nozzle in accordance with the exemplary embodiment in the area relevant to the present invention. Accordingly, the jet nozzle, in particular on the inlet side, can be further designed, i.e., for example prepared for a connection to a liquid supply or similar.

The proposed jet nozzle illustrated in FIGS. 2 and 3 according to a second exemplary embodiment exhibits—to a substantial degree—structural and functional parallels to the jet nozzle according to FIG. 1. These are reflected in the use of identical reference marks for matching, functionally identical, or mutually corresponding components. Where matching references are used as in the foregoing embodiments, a repeated description of the jet nozzle is omitted and instead the previous explanation of FIG. 1 is referred to. As variations of the jet nozzle according to FIG. 1, the following aspects and characteristics are to be noted:

The jet forming body 6 is configured in two parts. It comprises (on the inflow side) a first part 37 in form of a substantially cone-shaped onflow cap 38 which is connected to the second part 39 comprising the main area 7 and the end section 9 (on the outflow side) by means of a plug connection 40. The second part 39 of the jet forming body 6 in turn is part of a complex one-part component which in addition comprises a support ring 41 surrounding the jet forming body 6 at some distance to form an annular flow channel 10, as well as several flat spokes 11 which support the second part 39 of the jet forming body 6 on the support ring 41. The flat spokes 11 are thereby configured in the form of twisted flow guide surfaces and create a swirl flow in the annular flow channel 10. For a particular advantageous manipulation of the flow situation they each feature two slits 42. As an alternative with an otherwise identical design of the complex component comprising the second part 39 of the jet forming body 6, the support ring 41 and the spokes 11, an axial orientation of the flow guide surfaces so that no swirl flow is created is possible.

The funnel membrane 12, the axial extent of which is again substantially equally proportioned as its outer diameter, is therefore with its peripheral region 14 clamped between the support ring 41 (incorporated in the housing 1) and the clamp sleeve 16. To ensure a firm fit of the funnel membrane 12, the support ring 41 and the clamp sleeve 16 are contoured to match the profile of the peripheral area 14 of the funnel membrane 12.

The main body 4 of the housing 1 of the jet nozzle has several substantially radial openings 47 in the jet forming area S. And the clamp sleeve 16 in turn also comprises a corresponding number of openings 43 which are aligned with those of the main body 4 of the housing 1. Thus, by means of these openings 47 and 43, the inside of the housing 1 in the jet forming area S is laterally vented, which, on the one hand, supports an undisturbed jet formation with different throughputs and orientations of the jet nozzle, and, on the other hand, promotes the drainage of any potentially accumulated water. A rotation of the clamp sleeve 16 and the main body 4 of the housing 1 relative to each other is harmless for said ventilation if the main body 4 of the housing 1 and/or the clamp sleeve 16 in the area of the division are fitted with an annular, air distribution effecting circumferential groove 44.

Furthermore, the end 45 of the housing 1 of the jet nozzle designated to the liquid inlet opening 2 is prepared for a reliable, tight tube or pipe connection. For that purpose, the main body 4 of the housing 1 comprises two circumferential ribs 46 in that area. Overall, the structure shown in FIGS. 2 and 3 clearly results in a markedly compact jet nozzle with integrated shutter function.

1. Liquid jet nozzle with the following features:
comprising a housing (1) with a liquid inlet opening (2) and a jet outlet opening (3);
arranged in the housing (1) is a jet forming body (6) around which liquid can flow freely, and an end section (9) that is tapered in the direction of the jet outlet opening;
between the housing (1) and the jet forming body (6) to at least a portion of its axial length an annular flow channel (10) is configured;
between the liquid inlet opening (2) and the jet outlet opening (3) is a jet forming area (S) with a flow channel, the passage crosssection of which can be altered;
in the jet forming area (S), the flow channel is radially outwardly delimited by an elastically deformable funnel membrane (12), the outer periphery of which is permanently sealed to the housing (1) and which is tapered in the throughflow direction (A) in order to automatically alter the passage cross-section according to the local liquid pressure, the funnel membrane (12) radially expands when the liquid pressure increases, and radially contracts when the liquid pressure decreases;
the alterable passage cross-section is configured in annular form with the jet forming body (6) extending into the funnel membrane (12),
the housing (1) comprises at least one opening (47) through which the inside of the housing (1) is laterally vented in the jet forming area (S).

2. Liquid jet nozzle according to claim 1, characterized in that the tapered end section (9) of the jet forming body (6) is substantially cone-shaped, whereby the jet forming body (6) terminates in a point (8), preferably in the flow direction.

3. Liquid jet nozzle according to claim 1, characterized in that the jet forming body (6) is mounted immovably in the housing (1).

4. Liquid jet nozzle according to claim 1, characterized in that upstream of the funnel membrane (12) in an annular space between the housing (1) and the jet forming body (6), spokes (11) supporting the jet forming body (6) are provided, which, most particularly preferred, are designed as flow guide surfaces.

5. Liquid jet nozzle according to claim 4, characterized in that the spokes (11) comprise openings in the form of slits (42).

6. Liquid jet nozzle according to claim 1, characterized in that it is configured as a valve nozzle with a closing device (27) arranged downstream of the liquid inlet opening (2) that opens and closes in accordance with a preliminary pressure.

7. Liquid jet nozzle according to claim 6, characterized in that the funnel membrane (12) forms part of the closing device (27), whereby, without liquid supply to the liquid inlet opening (2), it rests with its inner periphery (19) on the outside of the jet forming body (6). With the supply of liquid to the liquid inlet opening (2) the inner periphery (19) of the funnel membrane (12) lifts up from the jet forming body (6) and uncovers an annular passage opening.

8. Liquid jet nozzle according to claim 7, characterized in that the inner periphery (19) of the funnel membrane (12) rests on the tapered end section (9) of the jet forming body (6).

9. Liquid jet nozzle according to claim 8, characterized in that the wall thickness of the funnel membrane (12) decreases in the throughflow direction.

10. Liquid jet nozzle according to claim 1, characterized in that on its outer periphery the funnel membrane (12) is affixed immovably to the housing (1).

11. Liquid jet nozzle according to claim 1, characterized in that the funnel membrane (12) comprises a bead-shaped outer peripheral region (14).

12. Liquid jet nozzle according to claim 1, characterized in that the housing (1) has an axial throughflow with the liquid inlet opening (2) being arranged opposite of the jet outlet opening (3).
